(19) United States
(12) Patent Application Publication
(10) Pub. No.: US 2009/0075015 A1
(43) Pub. Date: Mar. 19, 2009

(54) Limited Play Optical Discs

(76) Inventors: Michael R. Detty, Rochester, NY (US); Lief C. Larson, Minneapolis, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/175,839

(22) Filed: Jul. 18, 2008

Related U.S. Application Data
(60) Provisional application No. 60/951,593, filed on Jul. 24, 2007.

(51) Int. Cl. B32B 3/02; B32B 9/00; B05D 3/12; B05D 5/06; G11B 7/00

(52) U.S. Cl. 428/64.6; 427/240; 427/256; 369/100; G9B/7

(57) ABSTRACT

An optical disc having machine-readable, information encoding features includes a coating comprising a tellurapyrylium dye irreversibly bleachable by light. The dye, once bleached, is operative to change the index of refraction of the dye to inhibit reading of the information encoding features.

### RELATED APPLICATIONS

This application claims the benefit of U.S. Provisional Patent Application Ser. No. 60/951,593, titled Limited Play Optical Discs, filed Jul. 24, 2007, which is hereby incorporated by reference.

### FIELD OF THE INVENTION

Embodiments of the invention generally relate to optical discs rendered unreadable after a limited number of plays.

### BACKGROUND OF THE INVENTION

Conventional optical discs have reached widespread acceptance as a low-cost, reliable storage medium for digital information including music, video, and data. One of the traditional advantages of optical discs is their ability to be played thousands of times without degrading the digital information. However, in some applications, this aspect of the conventional optical disc represents a disadvantage by allowing the digital information to be used or copied more than the creator of the digital information desires. Although some discs have been provided with features to frustrate unlimited use, these discs have typically only temporarily rendered the disc unreadable. Further, known discs that are rendered permanently unusable have generally been rendered unreadable in response to time, such as by oxidation after the removal of a barrier layer. Such discs do not provide optimum qualities of rendering a disc permanently unreadable in response to the number of uses.

### BRIEF SUMMARY OF THE INVENTION

Some embodiments of the invention include a limited play optical disc comprising a substrate having machine-readable information encoding features and a coating comprising a tellurapyrylium dye irreversibly bleachable by light. In such embodiments, the information encoding features are machine-readable prior to bleaching of the dye, which may be activated by light. The bleached dye, however, alters the disc to inhibit further reading of the information encoding features. The dye can be bleached by a number of readings of the disc, as, for example, by exposure to light associated with reading of the disc. Embodiments of the optical discs have a relatively short effective life, limited by the number of times the disc is played (e.g. one, two, three or more times). Embodiments of the invention also include methods of making and using a limited play optical disc.

### BRIEF DESCRIPTION OF THE DRAWINGS

FIG. 1 shows a cross section view of a disc in accordance with some embodiments of the invention.

FIG. 2(a) shows information encoding features in accordance with some embodiments of the invention.

FIG. 2(b) shows an enlarged view of a portion of FIG. 2(a).

FIG. 2(c) shows a read pattern in accordance with some embodiments of the invention.

FIG. 3 shows read patterns in accordance with some embodiments of the invention.

FIG. 4 shows a dispersion curve for polycarbonate in accordance with some embodiments of the invention.

FIG. 5A shows a dispersion curve for a tellurapyrylium dye in accordance with some embodiments of the invention.

FIG. 5B shows a dispersion curve for a tellurapyrylium dye in accordance with some embodiments of the invention.

FIG. 6 shows a schematic of a tellurapyrylium dye and before and after bleaching representations of the dye in accordance with some embodiments of the invention.

FIG. 7 shows a schematic of a tellurapyrylium dye and before and after bleaching representations of the dye in accordance with some embodiments of the invention.

FIG. 8 shows a schematic of a tellurapyrylium dye and an after bleaching representation of the dye in accordance with some embodiments of the invention.

FIG. 9 shows a schematic of a tellurapyrylium dye and before and after bleaching representations of the dye in accordance with some embodiments of the invention.

FIG. 10 shows a schematic of a tellurapyrylium dye and the rate of change of transmittance of the dye as a function of exposure to a laser.

### DETAILED DESCRIPTION OF THE INVENTION

The following detailed description should be read with reference to the drawings, in which like elements in different drawings are numbered identically. The drawings, which are not necessarily drawn to scale, depict selected embodiments and are not intended to limit the scope of the invention. Several forms of the embodiments will be shown and described, and other forms will be apparent to those skilled in the art. It will be understood that embodiments shown in drawings and described are merely for illustrative purposes and are not intended to limit the scope of the embodiments as defined in the claims that follow.

Optical discs enable high storage capacity coupled with a reasonable price per megabyte of storage. Use of optical media has become widespread in audio, video, and computer data applications in such formats as, for example, compact disc (CD), compact disc read only memory (CD ROM), digital versatile disc (DVD) including multi-layer structures like DVD-5, DVD-9, and multi-sided formats such as DVD-10, and DVD-18, magneto-optical disc (MO), other write-once and re-writable formats such as CD-R, CD-RW, DVD-R, DVD-RW, DVD+RW, DVD-RAM, high definition optical discs such as Blu-ray and HD DVD, volumetric playback structures, and the like.

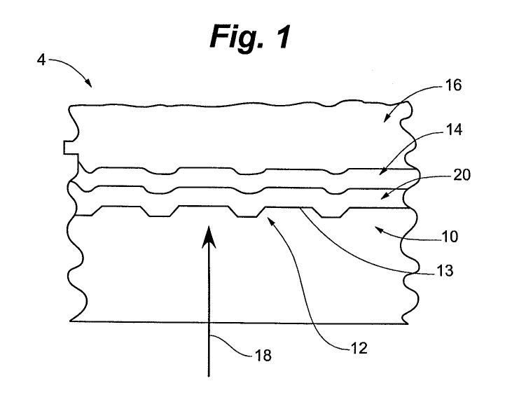

FIG. 1 shows a highly schematic cross section of an optical disc 4 in accordance with some embodiments of the invention. The disc 4 of FIG. 1 includes a substrate 10, which may be formed of any suitable material (e.g., polycarbonate). The substrate 10 may include an array of information encoding features. As used herein, the term “information encoding features” is intended broadly to encompass the widest possible range of such features, regardless of the particular encoding mechanism or reading beam interaction mechanism that is used. For example, the information encoding features may include pits 12 and lands 13. In some embodiments the pits and lands define one or more outputs selected from the group consisting of a song, movie, software and combinations thereof. The disc 4 may also include a reflective layer 14, which may include, for example, aluminum and/or gold. The reflective layer 14 may be covered with a protective layer 16, such as a lacquer, which protects the reflective layer 14 from oxidation and physical damage. A reading beam aligned with the arrow 18 may be incident on the surface of the substrate 10 opposite the information encoding features to read the information contained therein.

During use, the reading beam (sometimes referred to herein as an incident beam) 18 passes through the substrate 10, is reflected by the reflective layer 14, and passes out through the substrate 10 and the information encoding features as a reflected beam for detection by a reading device. In some embodiments the reading device is selected from the group consisting of a disc drive, CD player, and DVD player. The reading device may include an optical source, such as a laser, that directs the reading beam against the disc 4. A detector senses returning radiation (i.e., the reflected beam) from the disc 4.

As shown in FIG. 1, some embodiments of the disc 4 comprise a coating 20 that includes a dye irreversibly bleachable by light. In such embodiments, the information encoding features are machine-readable prior to bleaching of the dye. The dye, once bleached by light, is operative to change the index of refraction of the dye to inhibit further reading of the information encoding features. Unlike many coatings adapted to inhibit further reading of a disc by changing absorbance upon bleaching, changing the index of refraction is irreversible, thereby making the disc permanently unreadable if so desired.

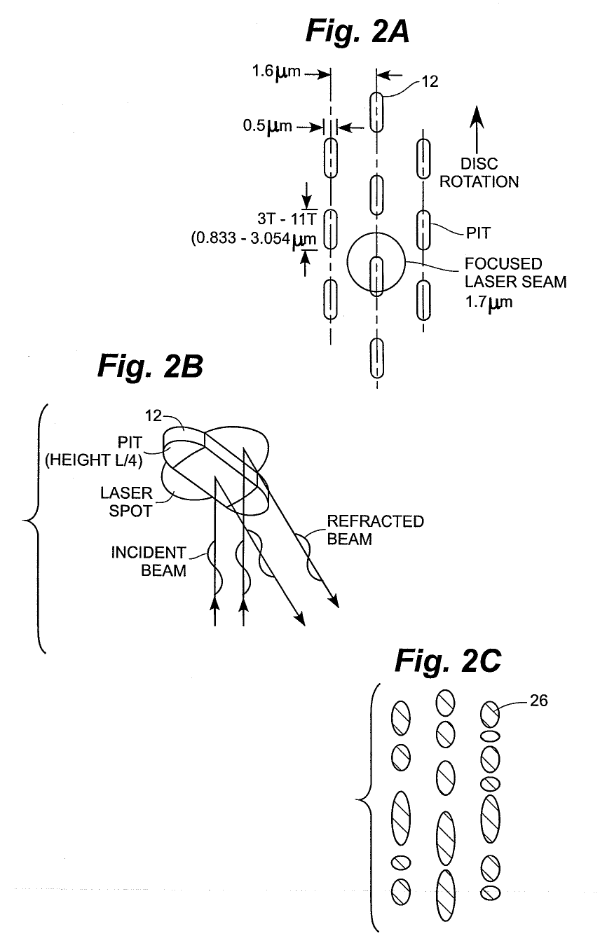

FIGS. 2(a)-(c), adapted from The Compact Disc Handbook by K. C. Pohlmann, A-R Editions, Inc., Madison, Wis., 1992, show the information encoding features being read on a typical optical disc. As an example, FIG. 2(a) schematically shows a 1.7 um laser spot (780 nanometers (nm)) passing over CD pit features (e.g., approximately 0.5 um wide by 100 nm deep with a 1.6 um track pitch). FIG. 2(b) illustrates an incident beam aimed at a pit and land and the collection optics receiving roughly equal amounts of light from a reflected beam from the land area and pit area of the information encoding features, the pit causing a wave phase shift (half wave double pass) compared to the land. The resulting interference yields the observed dark features on a bright background as shown in FIG. 2(c) when the disc is read at 780 nm, thereby transferring the information to a beam reader, such as a CD player. As another example, a similar readout would be observed for DVD pit structures with the wavelength at 650 nm, smaller pit dimensions, and a 0.8 um track pitch.

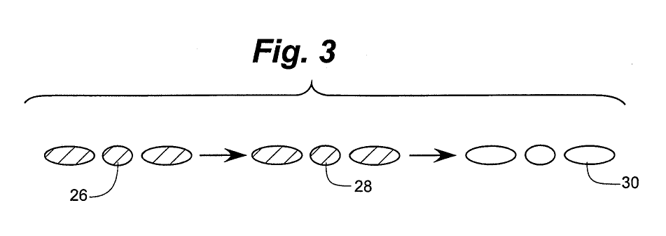

Upon sufficient exposure to the reading beam, the dye in the coating 20 undergoes a change in index of refraction to sharply reduce the information encoding feature contrast, resulting in unrecoverable data. As shown in FIG. 3, uncoated information encoding features of an uncoated disc may be represented by dark spots 26. These spots are read by the incident light beam to reproduce the information contained in the information encoding features. The coating 20 containing the dye may be placed in apposition to the information encoding features (e.g., pits and lands). The pits 12 generally have the same locations and length as uncoated discs, but generally have a different (e.g., greater or lesser) depth. For example, the depth of the pit relative to the land may be greater than about 150 nm (e.g., between about 150 nm and about 300 nm). In some embodiments, the depth of the pit relative to the land is greater than about 200 n. In yet other embodiments, the depth of the pit relative to the land is greater than about 250 nm. In other embodiments, the depth of the pit relative to the land is less than about 100 nm. In yet other embodiments, the depth of the pit relative to the land is less than about 75 mm. In other embodiments, the depth of the pit relative to the land is less than about 50 nm. These depths may be contrasted with typical discs, which generally have a pit depth of about 100 nm to about 130 nm relative to a land. The optimal pit depth may be determined for a given application by taking into account the optical properties of the dye, the thickness of the dye coating, and the extent the dye conforms to the underlying pit structure. As an example, for a change in index of refraction of 3 and a 50% conformal coating, a desired pit depth would be about 63 nm. Before bleaching of the dye, the information encoding features appear as dark spots 28, and the information defined by the information encoding features remains readable. After bleaching of the dye, however, the resulting change in index of refraction causes the information encoding features to appear as low-contrasting light spots 30 to the interrogation beam, thereby rendering the information unreadable. Lights spots 30 only need to be light enough to reduce the contrast below that which renders the discs unreadable. It should be noted that dual layer discs with multiple layers of information encoding features also work as described above, with each layer of information encoding features being unreadable after a change in index of refraction of a dye coating layer.

Embodiments of the optical discs have a relatively short effective life, limited by the number of times the disc is played (e.g. one, two, three, five or more times). In some embodiments the disc is read more than once before further reading is inhibited. In some embodiments the disc is read more than twice before further reading is inhibited. Further, the dyes are useful for rendering the disc permanently unreadable after a limited number of uses. The number of times the disc is read before permanent bleaching may be pre-determined by the selection of dye and the presence or absence of bleaching accelerators. The dye coating may be of a sufficient thickness and sensitivity to bleach in response to the laser intensity typically emitted from a standard disc reader, in contrast to dye coatings having a thickness and sensitivity that can only be activated in response to the typically higher intensity lasers utilized in disc writers.

In some embodiments, the dye irreversibly bleachable by light is selected from the group consisting of tellurapyrylium dyes. Generally, tellurapyrylium dyes include aromatic, benzenoid-like heterocycles consisting of a tellurium atom bearing a positive charge in a six-membered ring with three double bonds. Tellurapyrylium dyes have a +2 oxidation state where the tellurium atom is conjugated with the carbon π-framework and a +4 oxidation state of the tellurium atom. In the +4 oxidation state, the tellurium atom is not conjugated to the carbon π-framework and the tellurapyrylium dyes with a +4 oxidation state of the tellurium atom have significantly shorter wavelengths of absorption (λₘₐₓ) than tellurapyrylium dyes with a +2 oxidation state of the tellurium atom. Embodiments of the invention utilize a change in oxidation state at the tellurium atom of a tellurapyrylium dye to cause a loss of a chromophore at the wavelengths of emission of the read laser of a reading device or to cause a large change in refractive index at the wavelengths of emission of the read laser of the reading device.

Embodiments of the invention utilize tellurapyrylium dyes to create an optical disc that has a limited number of plays due to loss of information read by the read laser of a reading device. Without intending to be bound by theory, it appears the primary means of accomplishing the loss of chromophore or the change in refractive index is the coupling of a photochemical reaction induced by the read laser with a chemical change in oxidation state at the tellurium atom of the tellurapyrylium dye. For example, the photochemical generation of singlet oxygen caused by the tellurapyrylium dyes absorbing the wavelengths of light emitted by the read laser and transferring this energy to ground state oxygen to produce singlet oxygen. Singlet oxygen then reacts with the tellurium atom of the tellurapyrylium dye to give the Te(IV) oxidation state and a new dye whose wavelengths of absorption and refractive index at a given wavelength have changed to render the information encoding features unreadable.

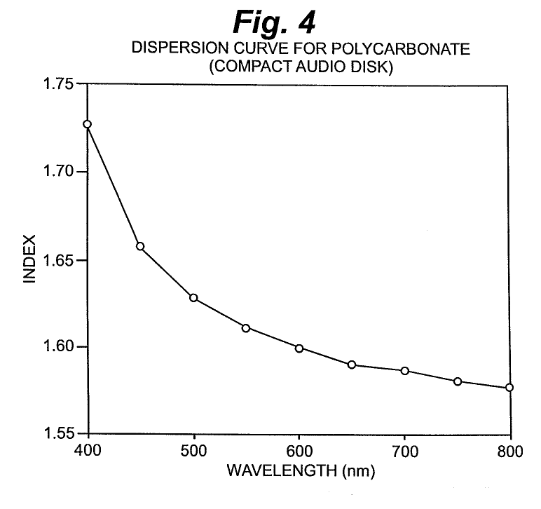

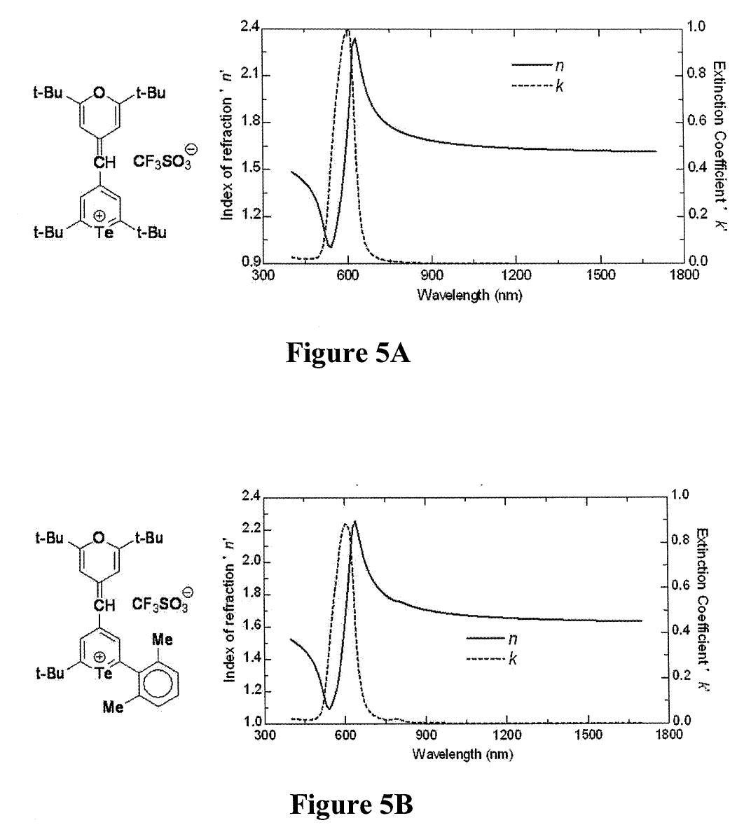

While any tellurapyrylium dye may be used, some embodiments of tellurapyrylium dyes useful in specific embodiments of the invention are tellurapyrylium dyes selected from the following classes of monomethine (compound I) or trimethine (compound II) shown below:

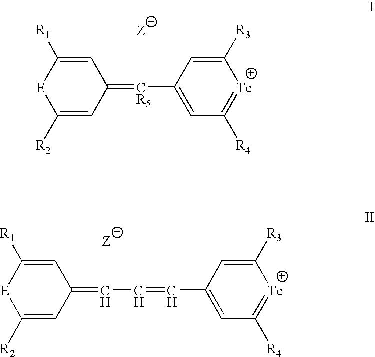

where the atom E is selected from O, S, Se, or Te;
the group Z is an anion selected from the halide salts chloride, bromide, or iodide, trifluoromethane sulfonate (CF₃SO₃⁻), tetrafluoroborate (BF₄⁻), hexafluorophosphate (PF₆⁻), perchlorate (ClO₄⁻) and the like;
the groups R₁, R₂, R₃, and R₄ are independently or together selected from the groups alkyl including methyl, ethyl, propyl, isopropyl, butyl, sec-butyl, tert-butyl and the like and other chains, either straight-chained or branched, consisting of one (1) to eight (8) carbon atoms; aryl groups including phenyl, substituted phenyl, naphthyl and the like; heteroaryl including 2-thienyl, 3-thienyl, 2-furyl, 3-furyl, pyridyl, and the like; and hydrogen; and
the group R₅ is selected from the groups hydrogen, alkyl including methyl, ethyl, propyl, isopropyl, butyl, sec-butyl, tert-butyl and the like and other chains, either straight-chained or branched, consisting of one (1) to eight (8) carbon atoms, cyano (CN), chloro, bromo, or iodo. Further, tellurapyrylium dyes possess large refractive indices and produce large index changes upon bleaching, allowing for relatively thinner coatings than dyes exhibiting smaller changes in index of refraction. As shown in FIG. 4, the index of refraction for a polycarbonate disc is about 1.6 in the 650 to 800 nanometer range. Generally, the index of refraction of a tellurapyrylium dye is about 2 to 2.5 in this range. As shown in FIGS. 5(a) and (b), the tellurapyrylium dyes of Examples II and III, respectively, (as described further below) have high refractive indices at 650 nm (solid lines), absorption maxima near 600 nm with significantly smaller absorbance at 650 nm (dashed lines).

Upon bleaching, the dye will have an index of refraction similar to the polycarbonate, resulting in a large change in the index of refraction. For example, some tellurapyrylium dye may provide a decrease of index of refraction of more than about 0.3 (e.g., about 0.4). As another example, some tellurapyrylium dye may provide a decrease of index of refraction of more than about 0.5 (e.g., about 0.7). In some embodiments, the tellurapyrylium dye may provide a decrease of index of refraction of more than about 1 (e.g., about 1.5) before bleaching and after bleaching.

The coating may have any thickness sufficient to provide the operable change in index of refraction without obscuring the information encoding features. In some embodiments, the coating has a thickness of less than about one micron. In some embodiments, the coating has a thickness of about 50 to about 300 nanometers. In yet further embodiments, the coating has a thickness of between about 100 to about 250 nanometers. The coating thickness may be chosen to correspond with the pit depth to achieve the one-half wave phase shift discussed above.

Further, the coating may be relatively conformal with the information encoding features. Conformality can be defined as the depth of the dye coated pit divided by the depth of the undyed pit. In some embodiments, the coating is about 25% to about 100% conformal with the information encoding features, and in some embodiments may be about 35% to about 65% (e.g., 50%) conformal. In such embodiments, the resulting dye filled pit depth may be a corresponding percentage of the uncoated pit depth.

In addition, in some embodiments the coating 20 does not significantly decrease the reflectivity of the optical disc. For example, in some embodiments, the reflectively of the disc and coating is greater than about 65%. Such embodiments are useful for reflecting light to be read by a common beam reader.

The coating 20 may be placed in any suitable position on or within the disc 4. In some embodiments the coating is in apposition to the substrate and/or information encoding features. Further, the coating 20 may be in apposition to the reflective layer 14, as shown in FIG. 1. In some embodiments the coating is deposited to cover a portion of the information encoding features, such as features defining a table of contents. In such embodiments, the disc becomes functionally unreadable although some of the information encoding features are readable.

In some embodiments, the coating is activated in response to light having a wavelength of about three hundred nanometers to about eight hundred nanometers. In some embodiments the coating is activated in response to light having a wavelength of about four hundred nanometers to about eight hundred nanometers (e.g., about 600 nm to about 800 nm). For example, the coating may show optimal change of index of refraction at about 650 nm in embodiments where the coating is provided on a DVD. In examples where the coating is provided on a CD, the coating may have an optimal change of index of refraction at about 780 nm. An example of a dye suitable for CD applications includes 4-[3-(2,6-di-tert-butylselenopyran-4H-ylidene)propen-1-yl]-2,6-di-tert-butyltellurapyrylium tetrafluoroborate. Of course, other wavelengths may be chosen. For example, activity in wavelength ranges of about 400 to about 425 nm may be useful in Blu-ray and/or HD DVD applications. In embodiments having a substrate comprising polycarbonate, the wavelength at which the polycarbonate absorbs an unacceptable amount of the light can set the lower limit of the wavelength.

In some embodiments, the coating may include one or more additives. For example, a photobleach accelerator may be provided. Such accelerators are useful for optimizing the rate at which the dye will bleach in response to light. An example of such an accelerator includes a borate and may include an organoborate, tetra phenyl boron, and/or n-butyl triphenylboron. Other accelerators include quinones as discussed in U.S. Pat. No. 4,201,588, the relevant contents of which are hereby incorporated by reference. Generally, accelerators having a charge opposite that of the dyes form one to one salts and are used directly as such. Accordingly, a 1:1 ratio of accelerator to dye molecules may be provided. Uncharged accelerators (such as, for example, the quinones cited above or trialkylamines such as Bis-tris (2,2-bis(hydroxymethyl)-2,2′,2″-nitrilotriethanol) can be utilized in any ratio (e.g., 9:1 dye to accelerator to 1:9 dye to accelerator).

Embodiments of the invention also include a method for inhibiting reading of an optical disc comprising the steps of providing any of the various embodiments of optical discs described above. In some embodiments the information encoding features are stamped into the substrate and the coating is deposited onto the substrate in apposition to the information encoding features. The coating may be deposited by any suitable method (e.g., spin coating), and the dye may be suspended in solution of various suitable solvents (e.g., alcohol) to facilitate deposition. The solvent may then be evaporated to leave behind a coating containing the dye.

Some embodiments of the invention include a method for inhibiting reading of an optical disc comprising the steps of acquisitioning any of the various discs described above and reading the disc with a reading device comprising a source of light and concurrently bleaching the dye to inhibit further reading of the information encoding features. The reading device comprises a source of optical radiation to read the disc and concurrently activate the coating to inhibit further reading of the information encoding features.

Embodiments of the invention as described above may be utilized in many applications. For example, in the DVD movie rental industry, the need for the customer to return the DVD after viewing is obviated because the disc would be rendered unreadable after a pre-determined number of viewings. Another example of a suitable application includes CDs. Such coated CDs would be useful for sending promotional CDs to a target audience, who would be able to play the songs a limited number of times before deciding whether to buy the uncoated version of the CD. As another example, unauthorized software downloading and file sharing could be reduced. For discs in accordance with embodiments of the invention containing software, a user would have a limited number of plays (e.g., three) to fully download the software before the disc is rendered unreadable. Therefore, the user would be discouraged from allowing others to download the software because it would permanently lose one of the plays.

### EXAMPLES

The following examples are presented for illustrative purposes and are not intended to limit the scope of the claims which follow.

### Example I

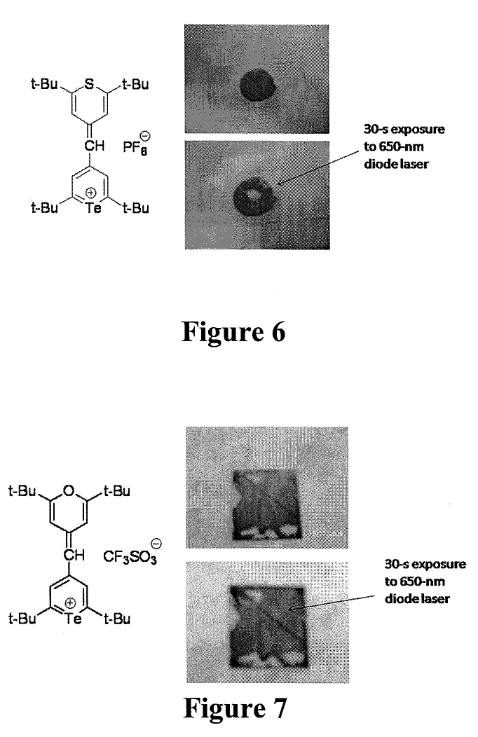

The tellurapyrylium dye, 4-[(2,6-di-tert-butylthiopyran-4H-ylidene)methyl]-2,6-di-tert-butyltellurapyrylium hexafluorophosphate, shown in FIG. 6 was dissolved in a 1:1 molar ratio solgel prepared from n-octyltriethoxysilane and tetraethoxysilane in ethanol with catalytic HCl, at a concentration of 1×10⁻⁴ M. The dye-solgel combination was coated on a glass microscope slide and allowed to dry for 2 h. The upper image of FIG. 6 shows the coated dye prior to exposure to a 650-nm diode laser. The lower image of FIG. 6 shows the same coating following 30 s of exposure to the diode laser at the spot indicated by the arrow.

In this example, the blue dye with tellurium in the +2 oxidation state is converted to a yellow dye with tellurium in the +4 oxidation state. The hue shift represents approximately a 200-nm blue shift in λₘₐₓ upon oxidation with a change in the index of refraction of about 0.5.

### Example II

The tellurapyrylium dye, 4-[(2,6-di-tert-butylpyran-4H-ylidene)methyl]-2,6-di-tert-butyltellurapyrylium trifluoromethanesulfonate, shown in FIG. 7 was dissolved in 1-methoxy-2-propanol to give a 2% by weight solution of the dye. The dye solution was spin-coated onto 1″×1″ glass slides. The upper image in FIG. 7 shows the coated dye prior to exposure to a 650-nm diode laser. The lower image in FIG. 7 shows the same coating following 30 s of exposure to the diode laser at the spot indicated by the arrow.

In this example, the blue dye with tellurium in the +2 oxidation state is converted to a yellow dye with tellurium in the +4 oxidation state. The hue shift represents approximately a 150-nm blue shift in λₘₐₓ upon oxidation with a change in the index of refraction of about 0.8.

### Example III

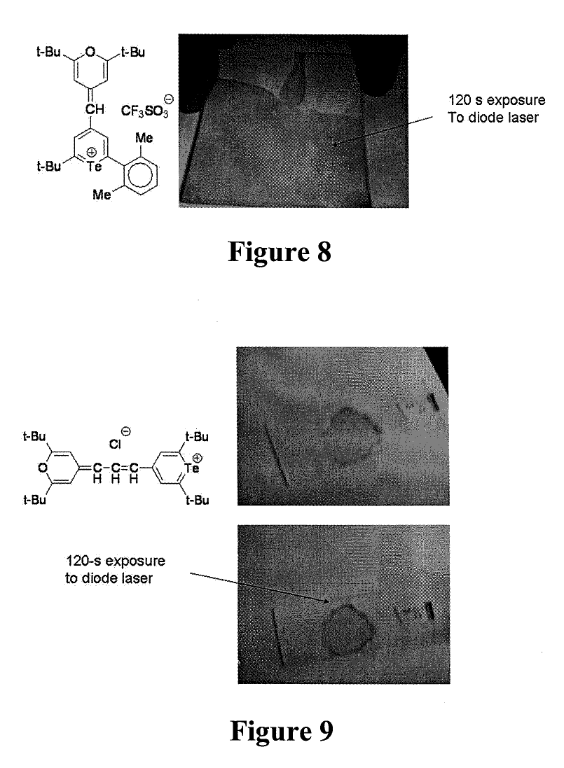

The tellurapyrylium dye, 4-[(2,6-di-tert-butylpyran-4H-ylidene)methyl]-2-tert-butyl-6-(2,6-dimethylphenyl)tellurapyrylium trifluoromethanesulfonate, shown in FIG. 8 was dissolved in 1-methoxy-2-propanol to give a 2% by weight solution of the dye. The dye solution was spin-coated onto 2″×2″ polycarbonate slides. The image of FIG. 8 shows the coated dye following 120 s of exposure to a 650-nm diode laser at the spot indicated by the arrow.

In this example, the blue dye with tellurium in the +2 oxidation state is converted to a yellow dye with tellurium in the +4 oxidation state. The hue shift represents approximately a 150-nm blue shift in λₘₐₓ upon oxidation with a change in the index of refraction of about 0.6.

### Example IV

The tellurapyrylium dye, 4-[3-(2,6-di-tert-butylpyran-4H-ylidene)propen-1-yl]-2,6-di-tert-butyltellurapyrylium chloride, shown in FIG. 9 was dissolved in a 1:1 molar ratio solgel prepared from n-octyltriethoxysilane and tetraethoxysilane in ethanol with catalytic HCl, at a concentration of 1×10⁻⁴ M. The dye-solgel combination was coated on a glass microscope slide and allowed to dry for 2 h. The upper image of FIG. 9 shows the coated dye prior to exposure to a 650-nm diode laser. The lower image of FIG. 9 shows the same coating following 120 s of exposure to the diode laser at the spot indicated by the arrow.

In this example, the blue dye with tellurium in the +2 oxidation state is converted to a yellow dye with tellurium in the +4 oxidation state. The hue shift represents approximately a 200-nm blue shift in λₘₐₓ upon oxidation with a change in the index of refraction of about 0.6.

### Example V

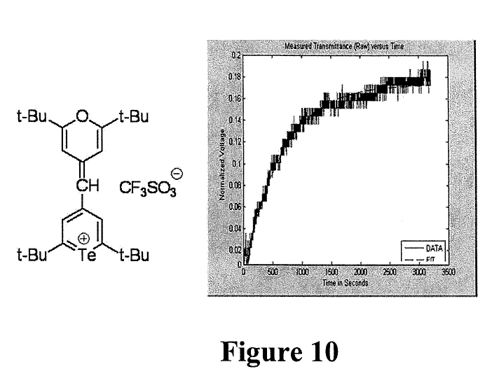

The tellurapyrylium dye, 4-[(2,6-di-tert-butylpyran-4H-ylidene)methyl]-2-tert-butyl-6-(2,6-dimethylphenyl)tellurapyrylium trifluoromethanesulfonate, shown in FIG. 10 was dissolved in 1-methoxy-2-propanol to give a 2% by weight solution of the dye. The dye solution was spin-coated onto 2″×2″ polycarbonate slides. FIG. 10 shows the rate of change in transmittance at 650-nm as a function of exposure to a 650-nm diode laser. The change in transmittance is the inverse of absorbance. As the dye bleaches, the transmittance increases.

### Example VI

DVD-Rs having a pit depth relative to the land of 180 nanometers were spin coated with tellurapyrylium dye from pressurized canisters with 3% solids (w/v) (3 grams of dye per 100 mls of solvent). Both the coating and edge-wash solvent was 1-methoxy-2-propanol having 99+% purity. The dye coating optical properties were n=2.15-0.15i at 650 nm. The average dye coating thickness was 110 nm with 50 nm on the land. The optical density of the dye coating was 0.23 at 650 nm.

The coated discs were run in a PULSTEC optical disc tester. The wavelength of the tester laser was 650 nm. The index of refraction of the dye coating started at approximately 2.12 and decreased from there based on absorption of the laser and bleaching of the dye. Various exposures were tested to determine the amount of exposure required to render the disc unreadable after two full plays with this particular coating layer. After several runs an exposure time of about 120-200 seconds was determined to be sufficient.

Thus, embodiments of the Limited Play Optical Disc are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A limited play optical disc, comprising:
a substrate having machine-readable information encoding features and supporting a reflective layer; and
a coating comprising a tellurapyrylium dye irreversibly bleachable by light supported by the substrate, the coating adapted to allow the information encoding features to be machine-readable prior to bleaching of the dye, the dye bleachable by the light, and operative, once bleached, to change the index of refraction of the dye to inhibit further reading of the information encoding features.

2. The disc of claim 1, wherein the information encoding features comprise pits and lands defining one or more outputs selected from the group consisting of a song, movie, software and combinations thereof.

3. The disc of claim 1, wherein the tellurapyrylium dye is selected from monomethines and trimethines.

4. The disc of claim 3, wherein the momonomethines and trimethines are selected from the group consisting of compound I and compound II; 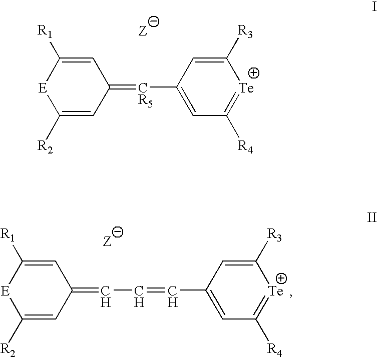
wherein the atom E is selected from the group consisting of O, S, Se, and Te;
the group Z is an anion selected from the group consisting of halide salts, chloride, bromide, iodide, trifluoromethane sulfonate (CF₃SO₃⁻), tetrafluoroborate (BF₄⁻), hexafluorophosphate (PF₆⁻), and perchlorate (ClO₄⁻);
the groups R₁, R₂, R₃, and R₄ are selected from the group consisting of alkyl, including methyl, ethyl, propyl, isopropyl, butyl, sec-butyl, and tert-butyl, straight or branched chains including one to eight carbon atoms; aryl groups including phenyl, substituted phenyl, and naphthyl; heteroaryl including 2-thienyl, 3-thienyl, 2-furyl, 3-furyl, and pyridyl; and hydrogen; and
the group R₅ is selected from the group consisting of hydrogen, alkyl including methyl, ethyl, propyl, isopropyl, butyl, sec-butyl, and tert-butyl, straight branched chains consisting of one to eight carbon atoms, cyano (CN), chloro, bromo, and iodo.

5. The disc of claim 1, further comprising a photobleach accelerator including a borate.

6. The disc of claim 1, the coating having a thickness of less than about one micron.

7. The disc of claim 1, wherein the disc is selected from the group consisting of a CD, DVD, and CD ROM.

8. The disc of claim 1, wherein the coating covers a portion of the information encoding features.

9. The disc of claim 1, wherein the index of refraction is reduced by more than about 0.5 upon bleaching.

10. The disc of claim 1, wherein the information encoding features include relatively deep pits and lands having a depth of greater than about 150 nanometers relative to the lands.

11. The disc of claim 1, wherein the coating is in apposition to and about twenty-five percent to about one-hundred percent conformal with the information encoding features.

12. A method for inhibiting reading of an optical disc, comprising the steps of:
providing an optical disc comprising a substrate having machine-readable information encoding features and a coating comprising a tellurapyrylium dye irreversibly bleachable by light, the information encoding features being machine-readable prior to bleaching of the dye, the dye bleachable by light and operative, once bleached, to change the index of refraction of the dye to inhibit further reading of the information encoding features.

13. The method of claim 12, wherein the information encoding features are stamped into the substrate.

14. The method of claim 12, wherein the coating is spin coated onto the substrate.

15. The method of claim 12, wherein the coating covers a portion of the information encoding features.

16. The method of claim 12, wherein the information encoding features comprise pits and lands defining one or more outputs selected from the group consisting of a song, movie, software and combinations thereof.

17. The method of claim 12, wherein the tellurapyrylium dye is selected from monomethines and trimethines irreversibly bleachable in response to light having a wavelength of about six hundred nanometers to about eight hundred nanometers.

18. The method of claim 17, wherein the momonomethines and trimethines are selected from the group consisting of compound I and compound II; 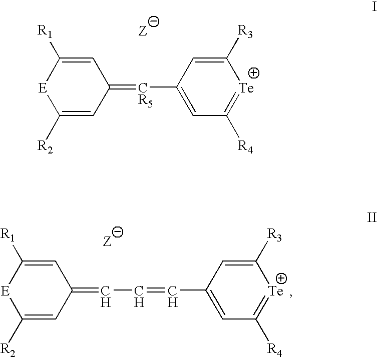
wherein the atom E is selected from the group consisting of O, S, Se, and Te;
the group Z is an anion selected from the group consisting of halide salts, chloride, bromide, iodide, trifluoromethane sulfonate (CF₃SO₃⁻), tetrafluoroborate (BF₄⁻), hexafluorophosphate (PF₆⁻), and perchlorate (ClO₄⁻);
the groups R₁, R₂, R₃, and R₄ are selected from the group consisting of alkyl, including methyl, ethyl, propyl, isopropyl, butyl, sec-butyl, and tert-butyl, straight or branched chains including one to eight carbon atoms; aryl groups including phenyl, substituted phenyl, and naphthyl; heteroaryl including 2-thienyl, 3-thienyl, 2-furyl, 3-furyl, and pyridyl; and hydrogen; and
the group R₅ is selected from the group consisting of hydrogen, alkyl including methyl, ethyl, propyl, isopropyl, butyl, sec-butyl, and tert-butyl, straight branched chains consisting of one to eight carbon atoms, cyano (CN), chloro, bromo, and iodo.

19. The method of claim 12, wherein the disc is selected from the group consisting of a CD, DVD, and CD ROM.

20. The method of claim 12, wherein the index of refraction is reduced by more than about 0.5 upon bleaching.

21. The method of claim 12, wherein the index of refraction is reduced by more than about 0.3 upon bleaching.

22. A method for inhibiting reading of an optical disc, comprising the steps of:
acquisitioning an optical disc comprising a substrate having machine-readable information encoding features and a coating comprising a tellurapyrylium dye irreversibly bleachable by light; and
reading the disc with a reading device comprising a source of light and concurrently bleaching the dye to inhibit further reading of the information encoding features.

23. The method of claim 22, wherein the disc is read more than once before further reading is inhibited.

24. The method of claim 22, wherein the disc is read more than twice before further reading is inhibited.

25. The method of claim 22, wherein the coating covers a portion of the information encoding features.

26. The method of claim 22, wherein the information encoding features comprise pits and lands defining one or more outputs selected from the group consisting of a song, movie, software and combinations thereof.

27. The method of claim 22, wherein the tellurapyrylium dye is selected from monomethines and trimethines irreversibly bleachable in response to light having a wavelength of about six hundred nanometers to about eight hundred nanometers

28. The method of claim 27, wherein the momonomethines and trimethines are selected from the group consisting of compound I and compound II; 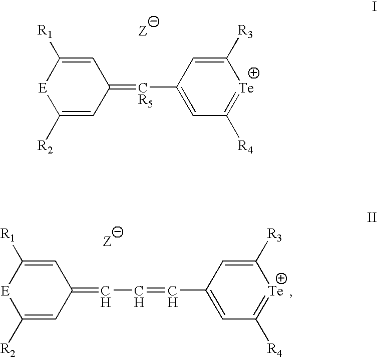
wherein the atom E is selected from the group consisting of O, S, Se, and Te;
the group Z is an anion selected from the group consisting of halide salts, chloride, bromide, iodide, trifluoromethane sulfonate (CF₃SO₃⁻), tetrafluoroborate (BF₄⁻), hexafluorophosphate (PF₆⁻), and perchlorate (ClO₄⁻);
the groups R₁, R₂, R₃, and R₄ are selected from the group consisting of alkyl, including methyl, ethyl, propyl, isopropyl, butyl, sec-butyl, and tert-butyl, straight or branched chains including one to eight carbon atoms; aryl groups including phenyl, substituted phenyl, and naphthyl; heteroaryl including 2-thienyl, 3-thienyl, 2-furyl, 3-furyl, and pyridyl; and hydrogen; and
the group R₅ is selected from the group consisting of hydrogen, alkyl including methyl, ethyl, propyl, isopropyl, butyl, sec-butyl, and tert-butyl, straight branched chains consisting of one to eight carbon atoms, cyano (CN), chloro, bromo, and iodo.

29. The method of claim 22, wherein the disc is selected from the group consisting of a CD, DVD, and CD ROM.

30. The method of claim 22, wherein the reading device is selected from the group consisting of a disc drive, CD player, and DVD player.

31. The method of claim 22, wherein the index of refraction is reduced by more than about 0.5 upon bleaching.

32. The method of claim 22, wherein the index of refraction is reduced by more than about 0.3 upon bleaching.
